(19) United States
(12) Patent Application Publication
(10) Pub. No.: US 2011/0287636 A1
(43) Pub. Date: Nov. 24, 2011

(54) MULTIFUNCTION PLUG CONNECTOR OF AN OIL PAN OF A VEHICLE

(75) Inventor: Georg ZWICKLER, Taunusstein (DE)

(73) Assignee: GM GLOBAL TECHNOLOGY OPERATIONS LLC, Detroit, MI (US)

(21) Appl. No.: 13/100,955

(22) Filed: May 4, 2011

(30) Foreign Application Priority Data
May 20, 2010 (DE) 102010022136.8

(51) Int. Cl. H01R 33/00

(52) U.S. Cl. 439/34

(57) ABSTRACT

A multifunction plug connector of an oil pan of a vehicle is provided having connection to a wiring harness of the vehicle outside the oil pan. Inside the oil pan, the multifunction plug connector has a supply line cable to an electronic component. The electrical component inside the oil pan is connected via an oil-tight feedthrough through the wall of the oil pan and via a plug connector situated outside the oil pan on a wall to the wiring harness of the vehicle. The plug connector has plug contacts or plug sockets for this purpose. Inside the oil pan, the multifunction plug connector has multiple separate supply line cables to multiple electronic components, which are connected to an engine control unit via the multifunction plug connector and the wiring harness.

### CROSS-REFERENCE TO RELATED APPLICATION

This application claims priority to German Patent Application No. 102010022136.8, filed May 20, 2010, which is incorporated herein by reference in its entirety.

### TECHNICAL FIELD

The technical field relates to a multifunction plug connector of an oil pan of a vehicle having connection to a wiring harness of the vehicle outside the oil pan. Inside the oil pan, the multifunction plug connector has a supply line cable to an electronic component. The electrical component inside the oil pan is connected, via an oil-tight feedthrough through a wall of the oil pan and via a plug connector situated outside the oil pan on a wall, to the wiring harness of the vehicle.

### BACKGROUND

A plug connector is known as a device for fill level display and monitoring of liquids from the publication DE 38 41 265 A1. However, the possible uses of the known device are extremely limited and have not grown to meet the requirements of modern engine controllers.

Therefore, at least one object of the application is to provide a multifunction plug connector, which has grown to meet the requirements of modern engine controllers and has improved flexibility and increased reliability. In addition, other objects, desirable features and characteristics will become apparent from the subsequent summary and detailed description, and the appended claims, taken in conjunction with the accompanying drawings and this background.

### SUMMARY

A multifunction plug connector of an oil pan of a vehicle is provided having connection to a wiring harness of the vehicle outside the oil pan. Inside the oil pan, the multifunction plug connector has a supply line cable to an electronic component. The electrical component inside the oil pan is connected, via an oil-tight feedthrough through the wall of the oil pan and via a plug connector situated outside the oil pan on a wall, to the wiring harness of the vehicle. The plug connector has plug contacts or plug sockets for this purpose. Inside the oil pan, the multifunction plug connector has multiple separate feed cables to multiple electronic components, which are connected via the multifunction plug connector and the wiring harness to an engine control unit.

This multifunction plug connector has the advantage that, using it, not only can a connection be provided to an oil level sensor via sensor lines, but rather it is now also possible to connect, in addition to sensor connections, both supply lines and also control lines via the multifunction plug connector on various components in an oil pan of a vehicle to the wiring harness outside the oil pan. In addition, the multifunction plug connector has the advantage that such various functions are possible via a single external plug connector in the area of the wall of the oil pan and a plurality of passages through the oil pan is not necessary, which would result in an increased sealing risk and could weaken the structure of the oil pan.

In an embodiment, the multifunction plug connector not only connects an oil level sensor in the oil pan via the wiring harness to the engine control unit, for which sensor cables are required, but rather additionally connects at least one electromechanical control valve of an oil pan to the engine control unit, for which control line cables are required. Such a control valve is used in modern volume flow oil pumps for the purpose of opening a second regulating chamber, to reduce the volume flow while simultaneously lowering the oil pressure.

Furthermore, it is provided that the multifunction plug connector has multiple through contacts in the area of the wall of the oil pan, which are situated insulated from the wall of the oil pan in the feedthrough and are materially bonded toward the oil pan using wires of the supply line cable to transition ends of the through contacts. This has the advantage that a plurality of sensor wires, supply wires, and/or control wires may be situated on such transition ends. Multiple wires of a supply line cable for components to be supplied with electrical current may also be connected to one supply feedthrough. Pinch connections may be used for this purpose as formfitting and friction-locked connections. Soft solder connections and/or hard solder connections are suitable as material bonds; diffusion welding connections are also possible.

In addition, it is provided that the transition ends and the wires of the supply line cable are embedded inside the oil pan in an electrically insulating plastic casting compound, from which the supply line cables protrude. Such plastic casting compounds may preferably be composed of a two-component plastic, whose chain molecules are cross-linked in such a manner that they form a duroplastic, which does not soften even at high oil temperatures.

In a further embodiment, the supply line cables of the multifunctional plug connector inside the oil pan have plug connectors on their free ends, which are insertable in an oil-tight manner into plug sockets or plugs of the electrical components. In this context, a plug connector is understood as an object which produces a plurality of electrical connections when plugged together and can be implemented as a plug socket or as a plug.

Furthermore, it is provided that the plug connector of the feedthrough on the wall outside the oil pan is electrically connected to the wiring harness of the vehicle via a counter plug connector. The final assembly of the vehicle can be made easier with the aid of this counter plug connector, because it is only necessary to plug in the counter plug connector to connect the components inside the oil pan to the wiring harness. This counter plug connector is also helpful in that the oil pan can be replaced as a single part readily in repair shops, without the wiring harness being incorporated in the repair.

In a further embodiment, a housing of the multifunction plug connector has a cylindrical section in the area of the feedthrough, which is adapted to an internal diameter of a tubular opening of the feedthrough through the wall. Furthermore, the cylindrical section has a ring groove, in which a ring seal is placed. This has the advantage that by simply plugging the cylindrical section having the ring seal into the tubular opening in the wall of the oil pan, the feedthrough through the wall can be produced in an oil-tight manner using few actions.

The housing preferably has a disc-shaped collar on its end inside the oil pan, which presses against the inner wall of the oil pan and merges into the cylindrical section, which is pluggable into the tubular opening in the wall. It is ensured by this form of the housing that the supply line cables, which practically end at the collar and are embedded there in a plastic casting compound may be installed using an insertion of the housing from the inner side of the oil pan to the outer side of the oil pan.

A groove can be provided in the cylindrical section on the outer side or the outer end of the cylindrical section, in order to attach an axially fixing clip ring after plugging the cylindrical section through the tubular opening. Instead of such a fixing clip ring, the cylindrical section can also have an external thread outside the oil pan, on which a fixing nut can be screwed before the outer plug connector is plugged on.

The through contacts are situated inside the cylindrical section of the housing, on whose inner transition ends the wires of the supply line cables are situated and on whose ends outside the oil pan the plug connector is pluggable. A counter plug can additionally also be provided as the transition to the wiring harness, as already mentioned above, in order to detach the oil pan having the plug connector from the wiring harness.

The housing of the through contacts itself can be produced from a duroplastic and thus have an insulating effect with respect to the wall of the oil pan from the beginning, however, it is also possible to produce the housing from a metal, in this case, the electrically conductive through contacts being embedded inside the housing in an insulating plastic compound. The electrical through contacts preferably have electrically conductive metal pins, on which corresponding sockets of a plug connector outside the oil pan are pluggable.

In order to associate plug connectors and the through contacts of the cylindrical section of the feedthrough of the housing exactly, the cylindrical section has at least one alignment recess in the axial direction, in which an alignment lug of the plug connector can engage. It is also provided that the plug connector can be plugged onto the cylindrical section of the housing, which protrudes from the wall of the oil pan, after axial fixing.

The housing having the through contacts and its fixing possibilities in the wall of the oil pan is only one part of the multifunction plug connector. The multifunction plug connector includes both the above-mentioned supply lines and also the plug connector on the free ends of the supply lines, which produce an electrical transition to corresponding plugs or plug sockets on the components, and outside the oil pan, the plug connectors attached there to the wiring harness.

### BRIEF DESCRIPTION OF THE DRAWINGS

The present invention will hereinafter be described in conjunction with the following drawing figures, wherein like numerals denote like elements, and:

FIG. 1 shows a schematic block diagram of a multifunction plug connector according to an embodiment;

FIG. 2 shows a schematic sketch of the multifunction plug connector according to FIG. 1;

FIG. 3 shows a disassembled, schematic view of an internal combustion engine with oil pan, in which the multifunction plug connector according to FIG. 1 is situated.

### DETAILED DESCRIPTION

The following detailed description is merely exemplary in nature and is not intended to limit application and uses. Furthermore, there is no intention to be bound by any theory presented in the preceding background or summary or the following detailed description.

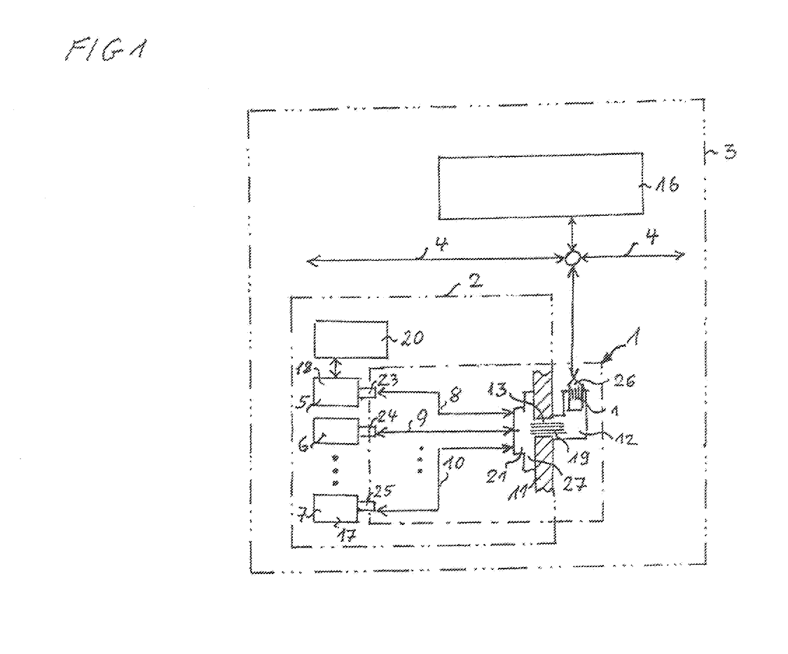

FIG. 1 shows a schematic block diagram of a multifunction plug connector 1 according to an embodiment. For this purpose, the areas of the block diagram which comprise the multifunction plug connector 1 are bordered using a dash-one-dot line. A multifunction plug connector is situated partially inside and partially outside an oil pan 2, whose outline is bordered using a dash-two-dot line. Such an oil pan 2 is situated in a vehicle 3, which is shown by a dash-three-dot line as an outline of the block for the vehicle 3.

As the schematic block diagram shows, the multifunction plug connector 1 extends both inside the oil pan 2 and also outside the oil pan 2. Inside the oil pan 2, the multifunction plug connector 1 has supply lines 8, 9, and 10, which end on one side at a feedthrough housing 27 and may have plug connectors 23, 24, and 25, respectively, on their free ends, to connect electronic components 5, 6, and 7 to the supply lines 8, 9, and 10, respectively.

The points shown between the components 6 and 7 are to indicate that the number of the electronic components connectable via the multifunction plug connector 1 using a feedthrough can be arbitrarily high. In this illustration, the electronic components 5 represent an electromechanical control valve 18, which cooperates with an oil pump 20 in the oil pan 2, control signals being delivered from an engine control unit 16 in the vehicle 3 via a wiring harness 4 and the multifunction plug connector 1 to the mechanically driven oil pump via the supply line 8.

The electromechanical control valve 18 solely has the task of switching on a second stage in the form of a pump chamber to reduce the volume flow through the oil pump 20. An oil level sensor 17 is provided as an electronic component 7, which delivers measuring signals via the supply line cable 10 to the wiring harness 4 and further to the engine control unit 16. Because such oil level sensors also require supply lines, to operate LEDs for the oil level measurement, for example, supply voltages and supply currents are also delivered to the individual electronic components via the multifunction plug connector 1.

While an inner area of a through housing 27 of the multifunction plug connector 1 is situated inside the oil pan 2, a plug connector 12 is provided outside the oil pan 2, which leads contacts 19 through the wall 11 of the oil pan 2 to a transition plug or counter connector 26, which can already be a part of the wiring harness 4. Therefore, the wiring harness 4 is disconnectable from the multifunction plug connector 1 for the oil pan 2 at this point. Both the plug connector 12 and also the counter plug connector 26 can be implemented as plugs or sockets.

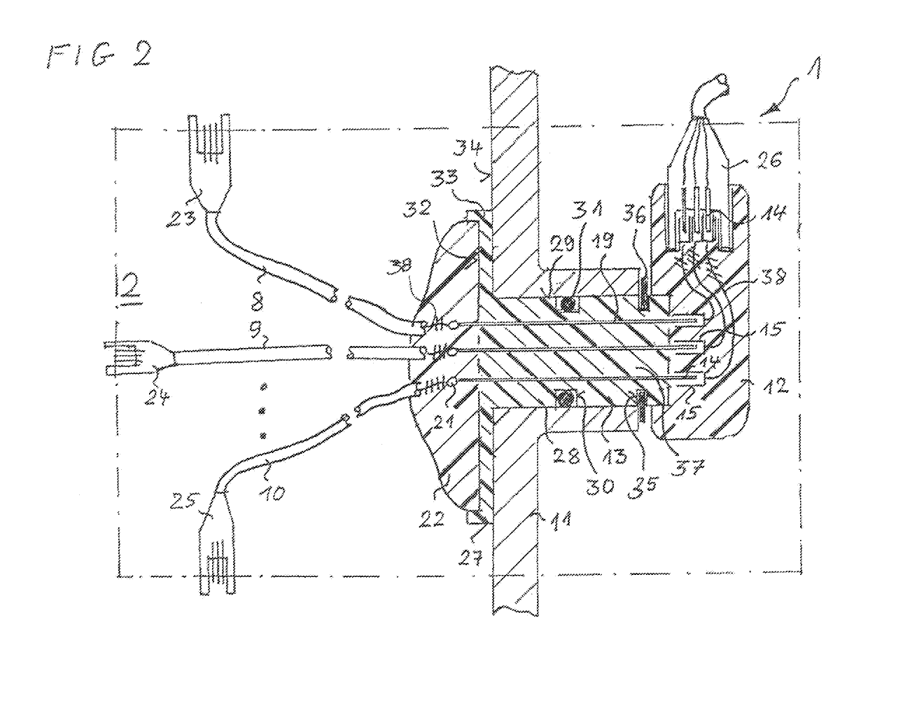

FIG. 2 shows a schematic outline in partial cross-section of the multifunction plug connector 1 according to FIG. 1. In this embodiment of the multifunction plug connector 1, a through housing 27 is pushed through a tubular opening 29 of the wall 11, a disc-shaped collar 33 being situated inside the oil pan 2 on an inner end 32 of the through housing 27 and pressing against an inner wall 34 of the wall 11 of the oil pan 2, while a cylindrical section 28 is inserted into the tubular opening 29 of the wall 11 of the oil pan 2.

In order to seal the through housing 27 in relation to the oil of the oil pan, a ring groove 30 is provided on the cylindrical section 28, into which a ring seal 31 is introduced, which seals the through housing 27 in relation to the tubular opening 29 of the wall 11. In order to axially secure this oil-tight feedthrough 13, in which electrically conductive through contacts 19 are situated, in this embodiment of the application, the cylindrical section 28 of the through housing 27 has a groove 35 above the oil pan 2, in which a clip ring 36 is situated, which secures the axial position of the through housing 27.

The through housing 27 can be constructed from a duroplastic and/or from metal. In the case of a metal through housing 27, the electrically conductive through contacts are embedded in an insulating plastic compound 37. Transition ends 21 of the through contacts 19 protrude from the insulating plastic compound 37 inside the oil pan 2, to which wires 38 of supply lines 8, 9, and 10 are materially bonded. Both the transition ends 21 and also the wires 38 of the respective supply line cables 8, 9, and 10 are embedded in an insulating plastic casting compound 22, from which the supply line cables 8, 9, and 10 protrude, which in turn merge into plug connectors 23, 24, and 25 to individual electronic components inside the oil pan 2. The cross strokes in FIG. 2 symbolize the number of the wires 38 per supply line cable 8, 9, or 10.

Outside the oil pan 2, plug sockets 15 of a plug connector 12 are plugged onto the plug contacts 14, which protrude from the cylindrical section 28 of the feedthrough housing 27, and which merges the through contacts 19 into corresponding terminals of a counter plug connector 26, so that the counter plug connector 26, which is connected to a wiring harness, produces the connection to the wiring harness by simple plugging into the plug connector 12 of the multifunction plug connector outside the oil pan 2.

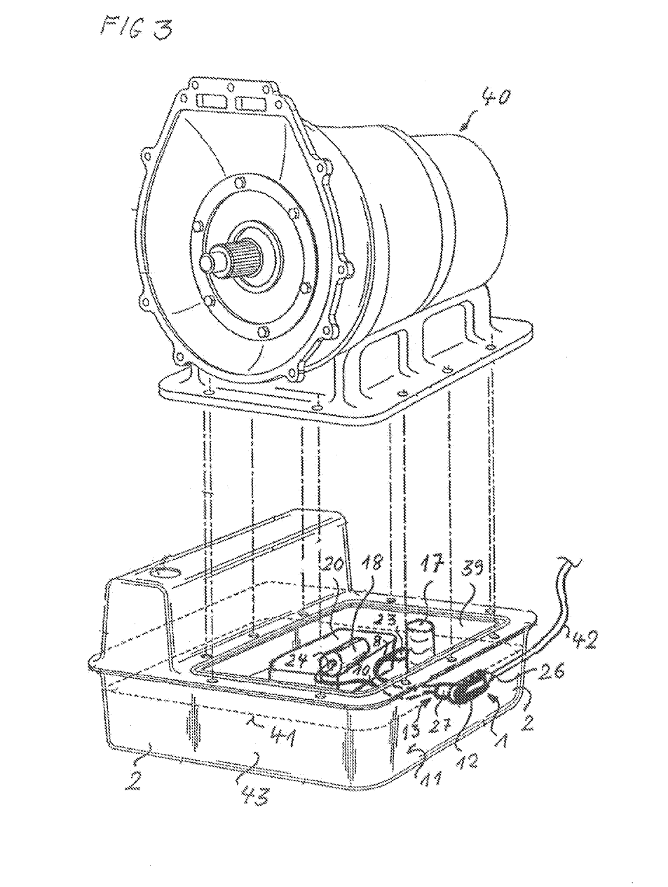

FIG. 3 shows a disassembled, schematic view of an internal combustion engine 40 having oil pan 2, in which the multifunction plug connector 1 is situated. The disassembled, schematic view of the internal combustion engine 40 exposes an opening 39 for looking into the oil pan 2, in which a two-stage oil pump 20 is situated in an oil sump 43, whose oil level 41 is marked by a dashed line, whose second regulating chamber can be opened or closed by an electromechanical control valve 18, to reduce the volume flow by reducing the eccentricity while simultaneously lowering the oil pressure.

An oil level sensor 17 is additionally situated in the oil pan 2, which partially protrudes over the oil level 41 and can transmit its measured values to an engine control unit 16 shown in FIG. 1 with the aid of the multifunction plug connector 1. For this purpose, both the oil level sensor 17 and also the electromechanical control valve 18 are connected via corresponding supply line cables 8 and 10 to a feedthrough 13 in a feedthrough housing 27, a plug connector 12 being situated outside the oil pan 2, which produces the connection to the wiring harness of the vehicle via a counter plug connector 26, via cable connections 42 outside the oil pan 2

While at least one exemplary embodiment has been presented in the foregoing summary and detailed description, it should be appreciated that a vast number of variations exist. It should also be appreciated that the exemplary embodiment or exemplary embodiments are only examples, and are not intended to limit the scope, applicability, or configuration in any way. Rather, the foregoing summary and detailed description will provide those skilled in the art with a convenient road map for implementing an exemplary embodiment, it being understood that various changes may be made in the function and arrangement of elements described in an exemplary embodiment without departing from the scope as set forth in the appended claims and their legal equivalents.

What is claimed is:

1. A multifunction plug connector of an oil pan of a vehicle, comprising:
a connection to a wiring harness of the vehicle outside the oil pan;
supply line cables connected to an electronic component inside the oil pan via a plug connector situated outside the oil pan on a wall and an oil-tight feed through the wall of the oil pan; and
a plurality of separate supply line cables to the electronic component, a second electronic component and a third electronic component situated inside the oil pan,
wherein the electronic component, the second electronic component and the third electronic component are connected via the plurality of separate supply line cables via the plug connector and via the wiring harness to an engine control unit.

2. The multifunction plug connector according to claim 1, wherein the multifunction plug connector connects at least one oil level sensor in the oil pan via the wiring harness to the engine control unit.

3. The multifunction plug connector according to claim 1, wherein the multifunction plug connector connects at least one electromechanical control valve of an oil pump via the wiring harness to the engine control unit.

4. The multifunction plug connector according to claim 1, further comprising a plurality of through contacts, which are insulated from the wall of the oil pan in the feed through and materially bonded toward the oil pan to the supply line cables at transition ends of the plurality of through contacts.

5. The multifunction plug connector according to claim 4, wherein the transition ends and wires of the supply line cables are embedded inside the oil pan in an electrically insulating plastic casting compound from which the plurality of supply line cables protrude.

6. The multifunction plug connector according to claim 1, wherein the plurality of supply line cables inside the oil pan comprise plug connectors that are pluggable in an oil-tight manner into plug of the electronic component, the second electronic component and the third electronic component.

7. The multifunction plug connector according to claim 1, wherein the plug connector of the feed through is electrically connected at the wall outside the oil pan to the wiring harness of the vehicle via a counter plug connector.

8. The multifunction plug connector according to claim 1, wherein a housing of the feed through comprises a cylindrical section that is adapted to an internal diameter of a tubular opening of the feed through that feeds through the wall, and the cylindrical section comprises a ring seal placed in a ring groove.

9. The multifunction plug connector according to claim 8, wherein the housing has a disc-shaped collar on an end inside the oil pan that presses against an inner wall of the oil pan and merges into the cylindrical section.

10. The multifunction plug connector according to claim 8, wherein the through contacts are situated inside the cylindrical section of the housing and on which the plug connector is pluggable outside the oil pan as a transition to the wiring harness.

11. The multifunction plug connector according to claim 8, wherein the cylindrical section outside the oil pan comprises a groove configured to receive an axially fixing clip ring.

12. The multifunction plug connector according to claim 8, wherein the cylindrical section outside the oil pan has an external thread onto which a fixing nut is fixed before plugging the plug connector.
